(19) United States
(12) Patent Application Publication
(10) Pub. No.: US 2018/0204654 A1
(43) Pub. Date: Jul. 19, 2018

(54) GRIPPER JAW AND CONDUCTOR GRIPPER FOR A PAIR OF ELECTRICAL OR OPTICAL CONDUCTORS

(71) Applicant: SCHLEUNIGER HOLDING AG, Thun (CH)

(72) Inventors: Roland KAMPMANN, Witten (DE); Marcus ZEISE, Radevormwald (DE); Uwe KEIL, Hückeswagen (DE)

(21) Appl. No.: 15/869,135

(22) Filed: Jan. 12, 2018

(30) Foreign Application Priority Data
Jan. 13, 2017 (EP) 17151522.4

(51) Int. Cl. H01B 13/02; H01B 11/02

(52) U.S. Cl. CPC H01B 13/0207; H01B 11/02

(57) ABSTRACT

A gripper jaw (G) for a conductor gripper (GA) for a pair of electrical or optical conductors (L1, L2), such as wires, cables, cable bundles or optical fibers. The conductor gripper (GA) has at least one gripper jaw (G) which is movable, by a drive assembly, relative to a second, oppositely positioned gripper jaw. The gripper jaw comprises at least one plate (1) having a gripper surface (2). The at least one plate (1) having a gripper surface (2) is mounted so as to be rotatable relative to a section that is secured against rotation (3) about an axis that is orientated perpendicularly to the gripper surface (2) and extends substantially through a middle of the gripper surface (2). The fixed section (3) is connected to the drive assembly or constructed therewith.

This application claims priority from European patent application serial no. 17151522.4 filed Jan. 13, 2017.

### FIELD OF THE INVENTION

The invention relates to a gripper jaw for a conductor gripper for a pair of electrical or optical conductors, and a conductor gripper for a conductor processing line.

### BACKGROUND OF THE INVENTION

It is essential for a high-quality twisting process for a conductor pair that the axial tensile force is identical in both conductors. If the conductors are pulled in and fed to the twisting process individually one after the other, the lengths of the conductors may be slightly different. The ends of the conductors are clamped in gripper jaws for twisting. If the lengths of the conductors are different, the sag in the two conductors is different (comparable to overhead power line sag). This differing sag (resulting from slightly different lengths of the individual conductors) results in a tendency to form unequal twisting loops (also called twisting nodes) in the twisted conductor pair during the twisting process, which is carried out at very high rotating speeds and involves correspondingly high centrifugal forces on the conductors and the ends thereof.

The same effect also occurs when a conductor pair is pulled in and fed to the twisting device together, and the setting of the conductor alignment mechanisms acts on the conductors differently. In this case as well, the sag in the two conductors to be twisted may be different, which leads to faults in the twisting process as described. Thus, the invention also assures an improvement of the twisting process using twisting machines which draw in the conductor pair to be twisted in parallel.

The requirement that in order to achieve good twisting quality the same tensile force must exist in the conductors that are to be twisted is already clearly defined in DE10107670A1. For this purpose, a special cable holding head is disclosed, in which a number of tension clamps is provided corresponding to the number of individual conductors to be twisted. A predetermined retaining pressure and a clamping pressure may be applied to the tension clamps, wherein the retaining pressure is lower than the clamping pressure. The retaining pressure serves to ensure that the individual conductors can still be pulled through by overcoming the friction force without causing significant damage to the individual conductors. After the individual conductors have been clamped, the clamping pressure is then applied to the tension clamps, allowing the individual conductors to be held or clamped firmly, preventing the individual conductors from slipping through. The cable holding head might also be designed so that it can twist and may thus be usable as a twisting head.

In order to prevent failures still more effectively when clamping the individual conductors to the predetermined length by moving the twisting head along the twisting axis, it is also suggested in DE10107670A1 that the twisting head is preferably rotated a predetermined number of revolutions. With this action in combination with the defined “slippage allowance” of the individual conductors while the twisting head is being moved, reliability with regard to failures is increased further.

A drawback of this known solution is that a complicated control and system design are necessary for setting the different pressures for retaining and clamping. Yet it is not possible to avoid damage to the conductors entirely, since a preselected retaining pressure cannot be adapted to all friction conditions between tension clamps and the conductor surface.

Document DE202009004913U1 discloses inter alia an embodiment in which, for a machine with only one driven twisting head, clamping points are provided on a circle whose centre is the axis of rotation for at least two conductors to be twisted. The purpose of this arrangement is to obtain equal tensile tension in all conductors through length compensation when pretensioning the twisting heads against each other. Accordingly, a clamping jaw that is capable of being placed under tension separately must be provided for each individual conductor. And each of these clamping jaws is preferably equipped with a separate length compensation element.

A drawback of this known solution is the complicated construction of the solution with separate clamping jaws, each of which must be actuated individually. The greater weight of the twisting head that this entails also has an unfavourable effect.

### SUMMARY OF THE INVENTION

The object of the present invention is therefore to create a device which is free from the aforementioned drawbacks and ensures a high-quality twisting process with a simple, lightweight device, in particular without risk of damaging the clamped conductors.

The object is solved with the features of the independent claims. Advantageous refinements are presented in the figures, the following description and in the dependent claims.

According to the invention, a gripper jaw is provided for a conductor gripper for a pair of electrical or optical conductors. These conductors may be for example wires, cables, cable bundles or optical fibres. At least one gripper jaw of the conductor gripper is movable relative to a second, oppositely positioned gripper jaw by means of a drive assembly, and the conductors are clamped between said two jaws. In this context, the gripper jaw has at least one plate with a gripper surface, which exerts the retaining and clamping force by means of friction when the gripper jaws approach the surface of the conductor.

The invention which is the object of this document is characterized in that the plate with the gripper surface is rotatable relative to a section that is secured against rotation about an axis of rotation that is aligned perpendicularly to the gripper surface and extends substantially through the middle of said gripper surface, whereas the stationary section is connected to the drive assembly or constructed therein. In such case, a passive rotatability is preferably provided and is sufficient. Typically, a mounting of the gripper surface which may be swiveled through a few degrees of rotation is sufficient. The phrase “through the middle” refers primarily to the middle of the connecting line between the sections of the gripper surface which serve to clamp the ends of the conductors. However, the axis of rotation preferably also lies centrally within the gripper surface when viewed in the longitudinal direction of the conductor ends.

The swiveling capability of the gripper surfaces that are in frictional lock with the conductor compensates for minor differences in the conductor lengths, so that equal tensile forces prevail in both clamped conductors following a slight movement apart from each other of the two clamped conductor ends, and both conductors have the same sag. In this way, the prerequisite for a high-quality twisting process is created.

Preferably, at least one elastic element is clamped between the plate with the gripper surface and the section that is secured against rotation, and the plate is impinged upon by a restoring force in such manner that the gripper surface is aligned substantially transversely to the connecting line with the opposing gripper jaw. In this way, the same starting condition of the gripper jaw is guaranteed for any clamping and twisting process. In this context, the term “transversely” includes all assemblies in which the longer dimension of the gripper surface—in which direction the conductor ends are located apart from each other when gripping—forms an angle of about 90° with the longitudinal direction of the conductors that are to be twisted.

According to the invention, an advantageous embodiment of the gripper jaw provides that at least one compression spring is inserted as an elastic element between the plate and the section that is secured against rotation. This is a simple, fault-resistant construction method. In this context, an embodiment is particularly preferred in which the or each compression spring is aligned substantially parallel to the connecting line with the opposite gripper jaw, thus enabling a compact size due to the capability to position the springs laterally beside the axis of rotation relative to the connecting line of the gripper jaws.

At least two elastic elements are preferably arranged symmetrically about the axis of rotation, which not only ensures a uniform mechanical load within the gripper jaw but also offers improved functional reliability due to the redundancy of the components exerting a restoring force towards the initial position.

Particularly preferred is an embodiment according to the invention in which the gripper surface, the elastic elements and the section that is secured against rotation form a unit that can be handled together and can be connected to the drive assembly or a fixed bearing. This ensures that the item can be replaced easily and quickly in the event of malfunctions, enabling the shortest possible interruptions in the process and simple retrofitting of existing conductor grippers with gripper jaws according to the invention.

A gripper jaw according to one of the preceding paragraphs may further be characterized according to the invention in that the rotating plate comprises at least two gripper surfaces, which are mounted in the plate so as to be rotatable relative thereto, wherein the axes of rotation of the rotatable gripper surfaces and of the rotatable plate are substantially parallel to each other. Here too, the gripper surfaces are preferably mounted so as to be passively rotatable in the rotating plate.

Initially, the conductors are aligned parallel to and at a distance from each other. During twisting, the two conductors are wound around each other—they are no longer parallel to each other. The conductor ends are ultimately arranged in a V-shape with respect to each other, wherein the V-dimension becomes shorter as twisting progresses and the loop length consequently becomes shorter and the V angle formed by the conductor ends becomes larger. The result of this effect is that the conductor ends clamped parallel between den gripper jaws are bent into this V region on the edges of the gripper jaws in the transition region, so that visible flexural buckling can occur. This unfavourable effect may be prevented with the advantageous embodiment explained in the preceding text, because the gripper surfaces rotating with respect to the gripper jaw ensure that the V-shaped position is maintained for one of each of the conductor ends.

The object stated in the introduction may also be solved for a conductor gripper for a conductor processing line for a pair of electrical or optical conductors. In such case, the line includes at least two conductor grippers, each having at least one gripper jaw, which conductor grippers are movable relative to each other and substantially perpendicularly to the position of the conductors by means of at least one drive assembly. The conductors may be for example wires, cables, cable bundles or optical fibres.

In order to solve the object and thereby obtain advantages and effects of such kind, according to the invention at least one of the gripper jaws is constructed as described in one of the preceding paragraphs.

According to the invention, a preferred embodiment of the conductor gripper is characterized in that the drive assembly comprises at least one elastic element which exerts a force on at least one conductor gripper or at least one gripper jaw away from the opposing conductor gripper or the opposing gripper jaw. In this way, the desired uniform pretension is created automatically in the conductors that are to be twisted without the need for substantial equipment assistance.

Alternatively, a further embodiment according to the invention may comprise a drive assembly having at least one controllable electrical or fluid drive which is able to bring about at least a movement of the conductor gripper or the gripper jaw away from the opposing conductor gripper or the opposing gripper jaw. With such an assembly, it is possible to set a pretension of the conductor that is precise and separately adaptable for each twisting process.

In such context, a measuring device is preferably connected to a controller for the drive assembly to at least indirectly determine the tensile tension in the conductors, in which controller a control circuit is implemented for specifying a user-definable tensile tension. This embodiment offers the best possible way to specify the optimal pretension for each conductor type and each process variant, wherein the greatest possible reliability may also be assured by the monitoring.

Further advantages, features and details of the invention are disclosed in the following description, in which exemplary embodiments of the invention are described with reference to the drawing.

The list of reference signs is an integral part of the disclosure in the same say as the technical content of the patent claims and the figures. The figures are described in interrelated manner, as a whole. The same reference signs stand for identical components, reference signs with different indices indicate functionally equivalent or similar components.

### BRIEF DESCRIPTION OF THE DRAWINGS

In the drawing:

FIG. 1 is a perspective view of an embodiment of a gripper jaw according to the invention,

FIG. 2 is an exploded view of the gripper jaw of FIG. 1,

FIG. 3 is a sectional view through the gripper jaw of FIG. 1 in a plane transverse to the connecting line with the opposing gripper jaw,

FIG. 4A is a schematic representation of two conductors of different lengths clamped in gripper jaws according to the invention before the length compensation, seen from above,

FIG. 4B is a view corresponding to FIG. 4A of the conductors and gripper jaws after the length compensation by moving the gripper jaws apart,

FIG. 5 is a perspective view of a further embodiment of a gripper jaw according to the invention,

FIG. 6 is an exploded view of the gripper jaw of FIG. 5,

FIGS. 7A to 7E are diagrammatic views of the conductor ends before, during and after the length compensation and the twisting process, with a further embodiment of the invention, and

FIG. 8 shows a twisting head with a conductor gripper corresponding to an embodiment according to the present invention.

### DETAILED DESCRIPTION OF THE PREFERRED EMBODIMENTS

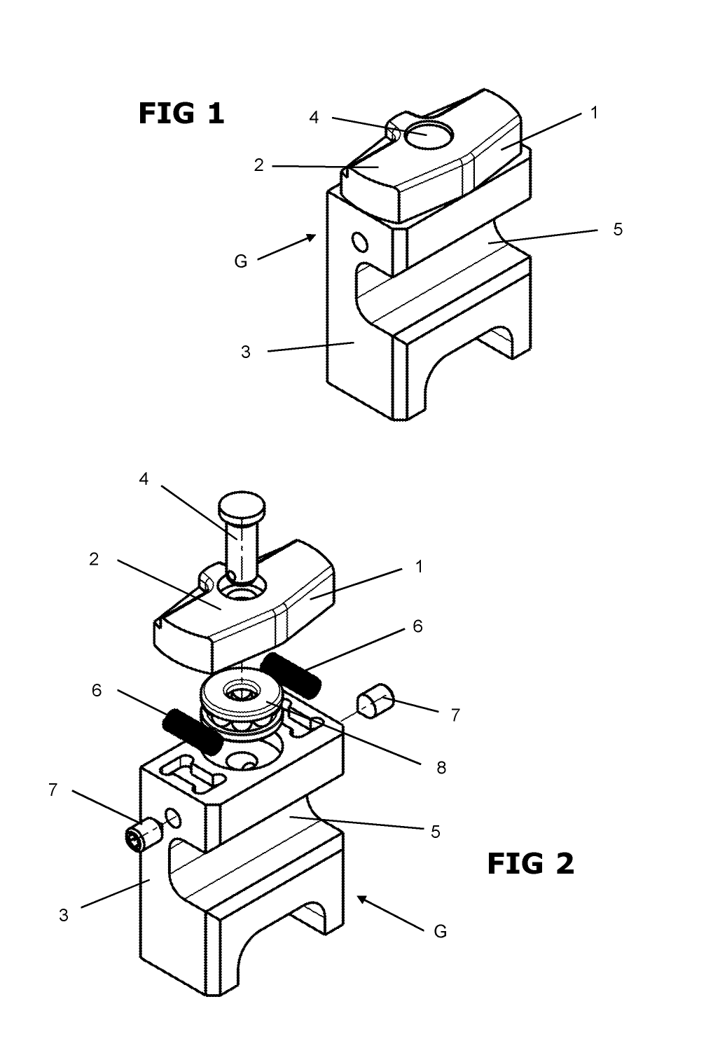

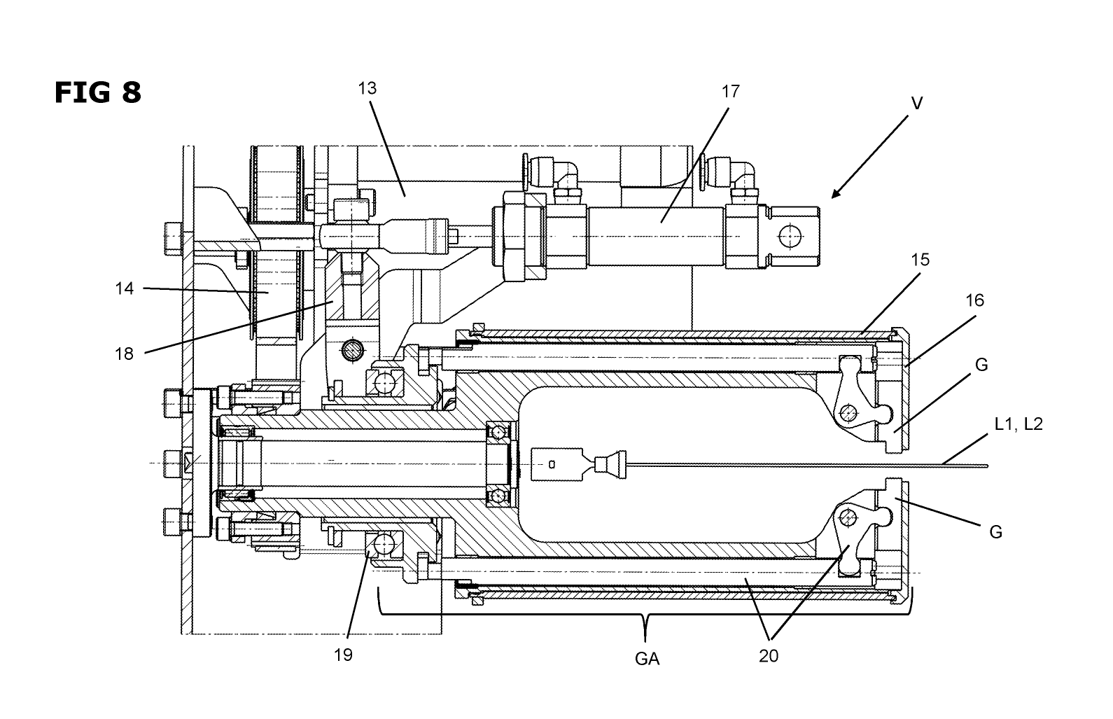

FIG. 1 shows a perspective view of a gripper jaw G, as is used in conductor grippers GA that clamp the conductors L1, L2 to be twisted in twisting heads V for example (see FIG. 8) for the twisting process. Conductor grippers GA of such kind may also be provided for pulling the conductors L1, L2 in drawing in devices or for transferring conductors L1, L2 to twisting heads or the like, for example, via transfer devices. Conductors L1, L2 may be electrical or optical conductors, such as wires, cables, cable bundles or optical fibres.

For the twisting operation within the more precisely defined meaning, that is to say twisting the mutually opposite conductor ends relative to each other, at least one gripper jaw G is movable relative to a second, opposing gripper jaw by means of a drive assembly. The two gripper jaws G are advantageously of the same construction. Both gripper jaws G are fastened to a carrier frame or the twisting head V on which said gripper jaws G are mounted is fastened to a carrier frame, wherein at least one gripper jaw G and/or twisting head V is/are movable not only rotationally but also towards and/or away from the opposing gripper jaw G and/or the opposing twisting head V.

The gripper jaw G according to the invention comprises at least one plate 1 with a gripper surface 2, wherein plate 1 with gripper surface 2 is rotatable relative to a section that is secured against rotation 3, for example a base body of gripper jaw G, about an axis of rotation which is aligned perpendicularly to gripper surface 2 end extends substantially through the middle of said gripper surface 2. Plate 1 is connected rotatably to fixed section 3 via a bolt 4, so that the axis of rotation of plate 1 is determined by the central axis of bolt 4. Fixed section 3 may be fastened to twisting head V for example, at any rate fastened detachably to enable repairs or adaptations to different conductors to be made.

Rotation out of the resting position is preferably carried out passively, i.e. solely as a result of the forces that are exerted when conductors L1, L2 are placed under pretension due to the differing conductor lengths. Fixed section 3 is typically designed in such manner that it can be replaced, or connected to the drive assembly and detached again, for example via a connecting structure—for which bolts 4 may also be used—or it is integrated in said drive assembly itself. In principle, active rotation of plate 1 via actuators of any kind is also conceivable, but this then typically requires an additional sensor system as well in order to synchronize the extent of the rotation precisely with the current assembly in each case.

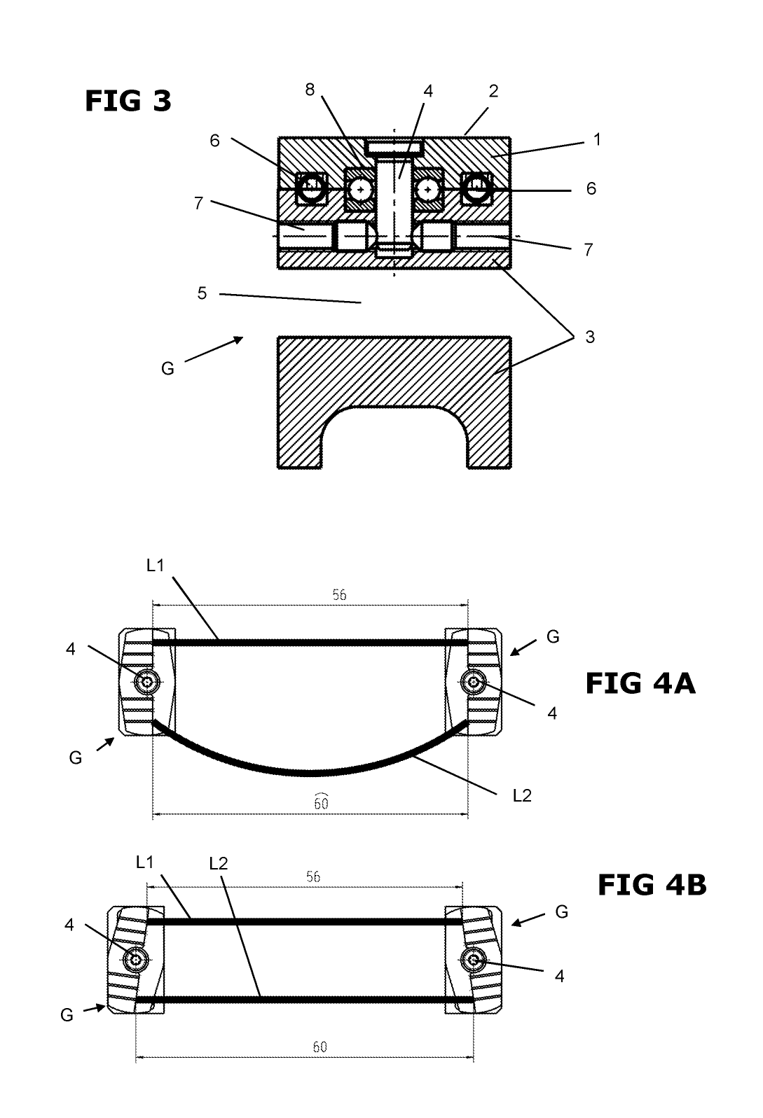

The exploded representation of FIG. 2 and the cross sectional view of FIG. 3 show clearly that of least one elastic element 6 is clamped between plate 1 with gripper surface 2 and the section that is secured against rotation 3. Preferably, two elastic elements 6 are arranged symmetrically on either side of the axis of rotation and of bolt 4, transversely relative to the connecting line between the mutually opposing gripper jaws G. A restoring force is exerted on plate 1 via the one or more elastic elements 6, preferably in the form of compression springs, aligning plate 1 and therewith also gripper surface 2 substantially transversely to the connecting line between the opposing gripper jaws G when no other force is acting on plate 1 or gripper surface 2. The one or more compression springs as elastic element 6 is/are preferably aligned parallel to the connecting line between the mutually opposing gripper jaws G.

FIG. 2 and FIG. 3 further show that bolt 4 is held in place in fixed section 3 via two threaded pins 7 which may be screwed into said fixed section 3, wherein said threaded pins 7 engage in boreholes on the bottom end of bolt 4, for example. The relative rotatability of plate 1 and fixed section 3 is assured via an axial ball bearing 8 for example.

Provided the fixed section 3 which is secured against rotation is not provided as part of the drive assembly for gripper jaws G, the connection between plate 1 and said fixed section by means of bolt 4 and threaded pins 7 has the additional advantage that plate 1 and section 3 are held together as a unit which can be manipulated together and connected to a fixed bearing, particularly on twisting head V or the drive assembly.

By virtue of the construction explained previously, plate 1 and therewith also gripper surface 2 may be swiveled through a few degrees of rotation from the plane aligned perpendicularly to the connecting line between the mutually opposing gripper jaws G. The resting or initial position which is parallel to this plane is determined by the restoring action of elastic elements 6.

Before the actual twisting operation during the overall twisting process, the conductors L1, L2 to be twisted are clamped at the same distance between gripper surfaces 2 on both sides of the twisting axis, which coincides with the connecting line between gripper jaws G that passes through bolt 4. Then, the specified axial tensile force is introduced into conductor pair L1, L2 before the actual twisting operation is performed. Ideally, both conductors L1, 12 are of equal length between the clamping points on both gripper jaws G (then, no swiveling movement of plates 1 with gripper surfaces 2 is necessary). Normally, however, the lengths of conductors L1 and L2 are slightly different, as is shown in FIG. 4A and emphasised by the length indicators “56” for L1 and “60” for L2. When the axial tensile force for pretensioning conductors L1 and L2 is applied by moving gripper jaws G apart via the drive assembly, plates 1—based purely mechanically on the balance beam principle—swivel out automatically depending on the length difference between L1 and L2 until the same tensile forces are present in both clamped conductors L1 and L2, which is represented in FIG. 4B,—or until a possible swivel limit stop between plate 1 and fixed section 3 is reached.

The horizontal swiveling of plate 1 and gripper surfaces 2 with the clamped ends of conductors L1 and L2 even through very few degrees of rotation, has the effect of causing the clamped conductor end to swivel through the the same angle as well. Moreover, as the degree of twisting of conductors L1, L2 progresses, the V-shaped end region of the conductor pair is altered in such manner that the angle between the conductor ends widens continuously, wherein an additional bending load is generated on the conductor ends.

Although the advantages according to the invention are also obtained if only one of the gripper jaws G is rotatable, it is preferable if both gripper jaws G are furnished with rotatable gripper surfaces 2, as is evident from FIGS. 4A and 4B.

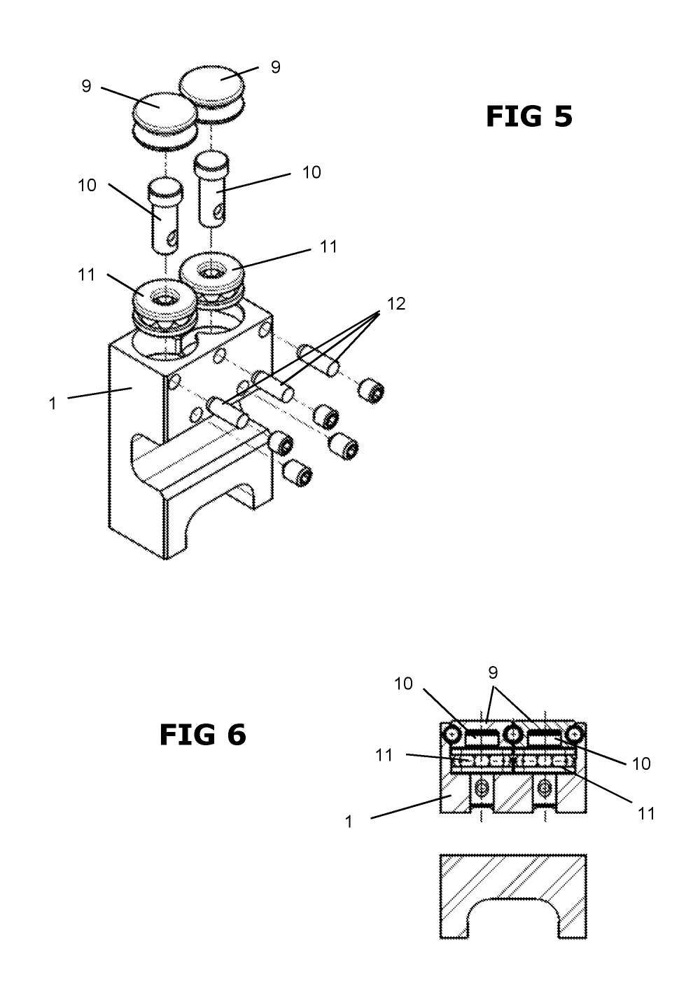

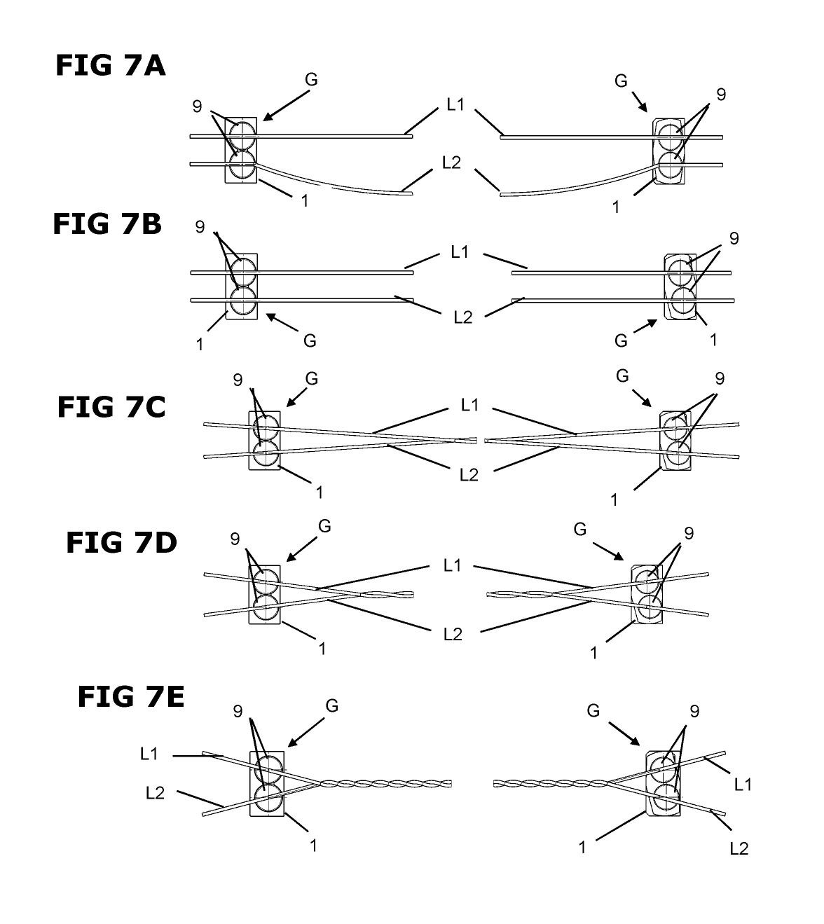

The further embodiment of the invention according to FIGS. 5 and 6 therefore provides that rotating plate 1 comprises of least two separate gripper surfaces 9 which can be rotated independently of each other, and which are mounted in swiveling plate 1 so as to be rotatable relative thereto and again preferably passively. For this purpose, gripper surfaces 9 are fastened to bolts 10, which are guided in axial ball bearings 11 for example and retained in plate 1 by means of threaded pins 12 that may be screwed into plate 1. The axes of rotation of the rotatable gripper surfaces 9 which are defined by the central axes of bolts 10 and the axis of rotation plate 1, which is defined by the central axis of bolt 4, are orientated substantially parallel to each other. In this way, the issue of reliably preventing buckling at the conductor ends during the twisting process is effectively addressed, as represented diagrammatically in FIG. 7A to FIG. 7E. The twisting process is carried out at relatively high rotating speeds. During the process, corresponding centrifugal forces are generated. Gripper surfaces 9 and their mountings must be designed so that only the tensile forces acting in conductors L1, L2 have an effect on the angular position of the gripper jaws, and that the centrifugal forces are neutralised.

The gripper jaw G is preferably implemented as part of a twisting head V such as is represented in FIG. 8. The entire gripper jaw G is preferably replaceable, particularly as a replacement for the gripper jaw pairs used conventionally and is arranged in the corresponding section of conductor grippers GA.

Twisting head V is typically part of a twisting device which, among other elements, is equipped with a drive motor 13 which drives twisting head V with the conductor gripper GA that comprises a plurality of assemblies via a drive belt 14 for example. The actual gripper jaws G are supported for example in linear guides in the front region of a twisting head housing 15. In order to replace the gripper jaws G, a front face end plate 16 on twisting head V is designed to be removable. The movement of the mutually facing gripper surfaces 2 of gripper jaws G for clamping and releasing the conductor ends is initiated by a preferably fixed position drive 17, possibly a pneumatic cylinder mounted on the carrier frame, via a lever 18, an axial roller bearing/thrust collar assembly 19 and a rod-lever assembly 20 which extends along the twisting head housing 15.

### LIST OF REFERENCE SIGNS

1 Rotating plate
2 Gripper surface
3 Fixed section
4 Bolt
5 Connecting structure
6 Elastic element
7 Threaded pin
8 Axial ball bearing
9 Rotating gripper surface
10 Bolt
11 Axial ball bearing
12 Threaded pin
13 Drive motor
14 Drive belt
15 Twisting head housing
16 Front face end plate
17 Drive for gripper jaws
18 Lever
19 Axial bearing/thrust collar assembly
20 Rod-lever assembly
G Gripper jaw
GA Conductor gripper
V Twisting head
L1, L2 Conductors

1-13. (canceled)

14. A gripper jaw (G) for a conductor gripper (GA) for a pair of electrical or optical conductors (L1, L2), and at least one gripper jaw (G) of the conductor gripper (GA) is movable by a drive assembly relative to a second, oppositely positioned gripper jaw,
wherein the gripper jaw (G) comprises at least one plate (1) having a gripper surface (2),
the plate (1) with the gripper surface (2) is rotatable relative to a section that is secured against rotation (3) about an axis that is orientated perpendicularly to the gripper surface (2) and extends substantially through a middle of said gripper surface (2), and
the fixed section (3) is connected to the drive assembly or constructed therewith.

15. The gripper jaw (G) according to claim 14, wherein the plate (1) with the gripper surface (2) is passively rotatable.

16. The gripper jaw (G) according to claim 14, wherein at least one elastic element (6) is clamped between the plate (1) with the gripper surface (2) and the section that is secured against rotation (3), and the at least one elastic element (6) exerts a restoring force on the plate (1) so that the gripper surface (2) is aligned substantially transversely to the connecting line with the oppositely positioned gripper jaw (G).

17. The gripper jaw (G) according to claim 16, wherein at least one compression spring is used as an elastic element (6) between the plate (1) and the section that is secured against rotation (3).

18. The gripper jaw (G) according to claim 16, wherein the elastic element (6) is aligned substantially parallel to the connecting line with the oppositely positioned gripper jaw (G).

19. The gripper jaw (G) according to claim 16, wherein at least one further elastic element is arranged between the plate (1) with the gripper surface (2) and the section that is secured against rotation (3).

20. The gripper jaw (G) according to claim 14, wherein the rotating plate (1) with the gripper surface (2) and the section that is secured against rotation (3) form a unit that can be handled together and can be connected to the drive assembly or a fixed bearing.

21. The gripper jaw (G) according to claim 14, wherein the rotating plate (1) comprises at least two gripper surfaces (9) which are mounted in the plate (1) so as to be rotatable relative thereto, and axes of rotation of the rotating gripper surfaces (9) and an axis of rotation of the rotating plate (1) are aligned substantially parallel to one another.

22. The gripper jaw (G) according to claim 21, wherein the at least two gripper surfaces (9) are mounted so as to be passively rotatable in the plate (1).

23. A conductor gripper (GA) for a conductor processing line, for a pair of electrical or optical conductors (L1, L2), wherein the line includes at least two conductor grippers, each of which has at least one gripper jaw (G), the conductor grippers are movable relative to one another and substantially perpendicularly to positions of the conductors (L1, L2) by at least one drive assembly, and at least one of the gripper jaws (G) is designed according to claim 14.

24. The conductor gripper (GA) according to claim 23, wherein the drive assembly comprises at least one elastic element which exerts a force on at least one conductor gripper (GA) or at least one gripper jaw (G) away from the opposing conductor gripper or the opposing gripper jaw.

25. The conductor gripper (GA) according to claim 23, wherein the drive assembly comprises at least one controllable electrical, magnetic or fluid drive, which is able to cause at least movement of the conductor gripper (GA) or the gripper jaw (G) away from the opposing conductor gripper or the opposing gripper jaw.

26. The conductor gripper (GA) according to claim 25, wherein a measuring device is connected to a controller for the drive assembly at least to determine indirectly tensile tension in the conductors, and a control circuit is implemented in the controller for specifying a user-definable tensile tension.

27. The gripper jaw (G) according to claim 16, wherein the elastic element (6) comprises at least two compression springs which are each aligned substantially parallel to the connecting line with the oppositely positioned gripper jaw (G).

28. The gripper jaw (G) according to claim 16, wherein in particular at least two elastic elements are arranged symmetrically about the axis of rotation.

29. The gripper jaw (G) according to claim 14, wherein at least the rotating plate (1) with the gripper surface (2), the at least one elastic element (6), and the section that is secured against rotation (3) form a unit that can be handled together and can be connected to the drive assembly or a fixed bearing.
